(19) United States
(12) Patent Application Publication
(10) Pub. No.: US 2016/0019892 A1
(43) Pub. Date: Jan. 21, 2016

(54) PROCEDURE TO AUTOMATE/SIMPLIFY INTERNET SEARCH BASED ON AUDIO CONTENT FROM A VEHICLE RADIO

(71) Applicant: Continental Automotive Systems, Inc., Auburn Hills, MI (US)

(72) Inventor: Marcin O. Klimecki, Northbrook, IL (US)

(21) Appl. No.: 14/332,506

(22) Filed: Jul. 16, 2014

(51) Int. Cl. G10L 15/26; G06F 17/30

(52) U.S. Cl. CPC G10L 15/26; G06F 17/30864; G06F 17/30746

(57) ABSTRACT

Audio obtained from a car radio is converted to digital data that is stored in a circular buffer, the size of which enables at least several seconds of audio to be recorded continuously. When a driver or passenger hears something of interest, data in the circular buffer is converted to strings of text. The text obtained from the recorded data is presented on a display device where individual text strings can be selected for transmission to an Internet search engine running on a computer or saved for the future use. The results of the Internet search are presented on the display device.

### BACKGROUND

As used herein, “infotainment” refers to systems in vehicles that provide information and entertainment to a driver and/or vehicle passengers. Information provided by such systems includes, but is not limited to, turn-by-turn driving directions and program content broadcast on the AM and FM radio bands or Satellite Broadcast and provided by the vehicle's radio receiver. Entertainment provided by an infotainment system can include music and video content. Information and entertainment can also include Internet connectivity provided by a data link between a cellular telephone in the vehicle and an Internet service provider.

Drivers and/or passengers receiving program content or information from a radio program may from time to time wish to obtain additional information or investigate stories heard on the car radio. A method and apparatus for assisting with the recovery of additional information by way of Internet searches would be an improvement over the prior art.

### BRIEF SUMMARY

In accordance with embodiments of the invention, audio obtained from a car radio is converted to digital data that is stored in a circular buffer, the size of which enables at least several seconds of audio to be recorded continuously. When a driver or passenger hears something of interest, data in the circular buffer is converted to strings of text. The text obtained from the recorded data is presented on a display device where individual text strings can be selected for transmission to an Internet search engine running on a computer or saved for the future use. The results of the Internet search are presented on the display device.

### BRIEF DESCRIPTION OF THE DRAWINGS

FIG. 1 is a block diagram of an apparatus to automate and simplify Internet searches using audio obtained from a vehicle radio;

FIG. 2 depicts the concept and operation of a circular buffer; and

FIG. 3 is a flow chart depicting steps of a method for automating Internet searches using audio obtained from a vehicle radio.

### DETAILED DESCRIPTION

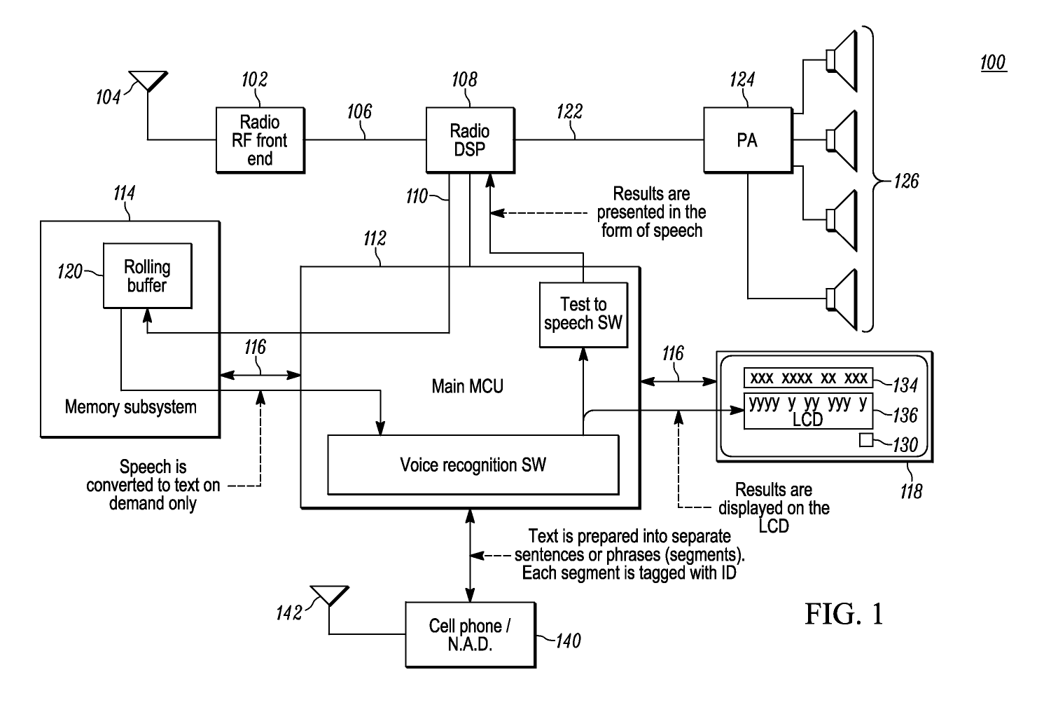

FIG. 1 is a block diagram of an apparatus 100 to automate and simplify Internet searches using audio obtained from a vehicle radio. The apparatus 100 continuously records audio received from a broadcast radio in a circular buffer. When a driver or vehicle occupant hears a story, a phrase, sentence, or speech that is of interest, upon a request, a copy of such content in the circular buffer is converted to text, which is displayed on a display device, preferably embodied as a touch-sensitive screen.

Sentences, phrases, or words that are converted to text are parsed and separated from each other to allow each sentence and/or phrase and/or word to be displayed on the screen, spatially separated from each other and individually selectable by touching the displayed phrase or sentence as it appears on the screen. A sentence, phrase, or word selected on the display device is provided to an Internet search engine running on a computer in the vehicle or running on a computer at a remote location. The results of the Internet search of the displayed and selected text that is obtained from the search engine is returned to and displayed on the screen. Internet searches of audio content obtained from a radio in a vehicle are thus automated and simplified.

In an alternate embodiment, audio that is converted to text, is re-converted to speech after a phrase or sentence is selected from the display device. The intelligibility of the speech that is synthesized from text that was prepared from recorded audio allows a driver to determine whether stored speech was correctly, i.e., accurately converted to text before sending the text to an Internet search engine. A selection of the sentence or phrase could also be made based on the synthesized speech read back to the user by means of voice recognition system.

Referring now to FIG. 1, the apparatus 100 comprises a conventional broadcast radio receiver 102. The radio 102 receives radio frequency signals in the commercial AM and FM bands from an antenna 104. The radio receiver 102 demodulates the RF signals using well-known prior art AM and FM demodulation techniques to provide an analog audio signal 106.

The audio 106 obtained by the radio 102 is provided to a digital signal processor 108. The digital signal processor or DSP converts the audio signals to a continuous stream of digital data 110. The stream of digital data is provided to a main processor 112, preferably a microcontroller or microprocessor, which is coupled to a non-transitory memory device or memory system 114, embodied as semiconductor RAM or a magnetic disk drive device, through a conventional address/data and control bus 116.

The memory 114 stores program instructions for the processor 112. When those instructions are executed by the processor 112, they cause the processor 112 to perform various functions that include, controlling the DSP 108, controlling the memory subsystem 114, and controlling a display panel 118. Program instructions stored in the memory subsystem 114 also cause the processor 112 to store the incoming stream of digital data 110 in a portion of the memory 114 controlled by the processor 112 to provide a circular buffer for the incoming digital data 110.

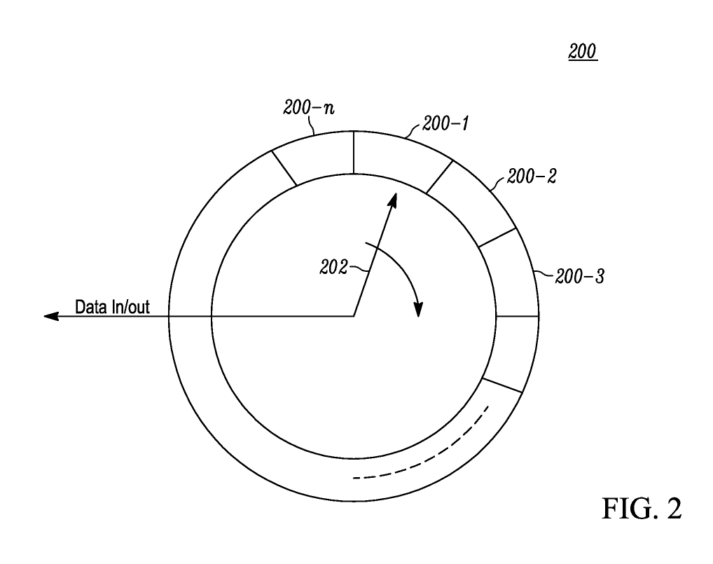

FIG. 2 depicts a circular buffer 200 conceptually. Memory locations 200-1, 200-2, 200-3 . . . 200-n are accessed sequentially, i.e., one after another, by a “rotating” pointer 202, which specifies or identifies a memory location into which, or from which, data is to be written or retrieved. Conceptually, as the pointer 202 rotates, its value circulates between a value required to access the contents of memory locations 200-1 through 200-n. Data in each location is thus eventually written over by new data as the pointer 202 value changes from 200-1 to 200-n.

A circular buffer is considered herein to be a data structure that uses a single, fixed-sized buffer as if it were connected end-to-end. A circular buffer thus functions as a first-in, first-out buffer or FIFO. Information is written into one end of the buffer continuously until the buffer is filled. When the buffer is filled, new incoming information is written over the previously stored information at the beginning of the buffer. Incoming information is thus continuously over writing previously-stored information such that the information in the buffer is only the data representing the last few seconds or minutes of received audio.

Referring again to FIG. 1, as received audio 106 is provided to the DSP 108 and converted by the DSP 108 to digital data 110 for storage in the circular buffer 120, the same analog audio 106 is provided by the DSP 108 to a conventional power amplifier 124. The analog audio 106 is amplified and output from loud speakers 126 located inside the passenger compartment of the vehicle, which is omitted from FIG. 1 for brevity.

As used herein, the term, “string” refers to a sequence of alphabetic and numeric characters that form words, sentences, and phrases. A “word” is considered to be a speech sound or series of speech sounds that symbolizes and communicates a meaning usually without being divisible into smaller units capable of independent use. “Sentence” refers to a word, clause, phrase, group of words, clauses, or phrases forming a syntactic unit and which expresses an assertion, a question, a command, a wish, an exclamation, or the performance of an action. In writing, a sentence usually begins with a capital letter and concludes with appropriate end punctuation. In speaking, a sentence is usually distinguished by characteristic patterns of stress, pitch, and pauses. A “phrase” is considered herein to be a word or group of words forming a syntactic constituent with a single grammatical function.

As stated above, the memory subsystem 114 stores program instructions which are executed by the processor 112. A set of instructions stored in the memory subsystem 114 causes the processor 112 to control the touch-sensitive display panel 118. Those instructions also cause the processor 112 to provide a tactile sensitive area 130 on the panel 118, i.e., a touch-sensitive area, appropriately labeled, e.g., by highlighting or outlining, to inform a user that actuation of the touch-sensitive area 130, i.e., touching it, will cause the processor 112 to stop or suspend recording incoming data 110 from the DSP 108 into the circular buffer 120 and to display instead on the display device 118, a computer-generated conversion of the stored audio as text. Stated another way, when a driver or passenger hears a particular sentence, phrase, or sounds from the loudspeakers 126 and touches a “softkey” or touch-sensitive area 130 or other user interface such as a button, the previously-recorded audio stored in the circular buffer 120 is recovered by the processor 112, parsed, and converted to separate strings of text, i.e., sentences, phrases or words, each of which is displayed on the screen 118 in corresponding touch-sensitive areas or regions 134, 136 of the display device 118. A driver or other occupant of the vehicle is thus able to recall the last few minutes or seconds of a story or speech of interest heard on the radio, have it automatically converted to text by the processor 112 and have the sentences, phrases, or even individual words presented on the screen as text for selection to be further processed, such as by an Internet search engine.

The processor 112 includes a voice recognition unit 132, which is embodied as stored program instructions. When the voice recognition unit 132 instructions are executed, they cause the processor 112 to stop recording incoming audio data 110, retrieve previously-stored data 110 from the circular buffer 120, recognize speech in the data 110, and convert that recognized speech into strings of text. One example of computer program instructions that convert speech to text is a computer program known as DRAGON® published by Nuance Communications, Inc. Other and additional instructions cause the text recovered from the speech data 110 to be provided to the display device 118 and displayed thereon in physically separate regions 134 and 136.

Regions 134 and 136 of the display device 118 where text is displayed, are “sensitized” by the processor 112 using prior art techniques, well-known to those of ordinary skill. The touch sensitization of the display areas 134, 136 enable a sentence or phrase displayed in a sensitized region 134, 136 to be selected by a user's touching the region 134 or 136 with a finger. In an alternate embodiment, a sentence or phrase that is “selected” by touching it on the screen 118 can be selectively sent to a text-to-speech converter 138, which is also embodied as program instructions stored in the memory device 114.

Reproducing the displayed text as audio enables a driver or other user to listen to text that was provided by the voice recognition unit 132 and determine whether the text generated by the voice recognition unit 132 is coherent. In other words, listening to audio that is generated from computer-generated text enables a user to test whether the string of text generated from the stored audio data 110 makes any sense.

A selected sentence or phrase that was accurately converted to text, as determined by a visual inspection of the text on the screen 118 or by “listening” to it, is provided by the processor 112 to a radio frequency transceiver 140, preferably embodied as a telematics' system network access device or cellular telephone.

The transceiver 140 provides a radio frequency data link 142 to an Internet service provider. The transceiver 140 thus provides Internet connectivity to the vehicle and the processor 112. A sentence or phrase recovered from the audio received by the radio 102 can thus be provided to an Internet search engine running on the processor 112 or some other processor located in the vehicle or at a remote location. The results of the Internet search are returned to the cell phone 140, the processor 112, and displayed on the panel 118. The apparatus depicted in FIG. 1 thus automates and simplifies Internet searches of phrases and information received from the vehicle radio.

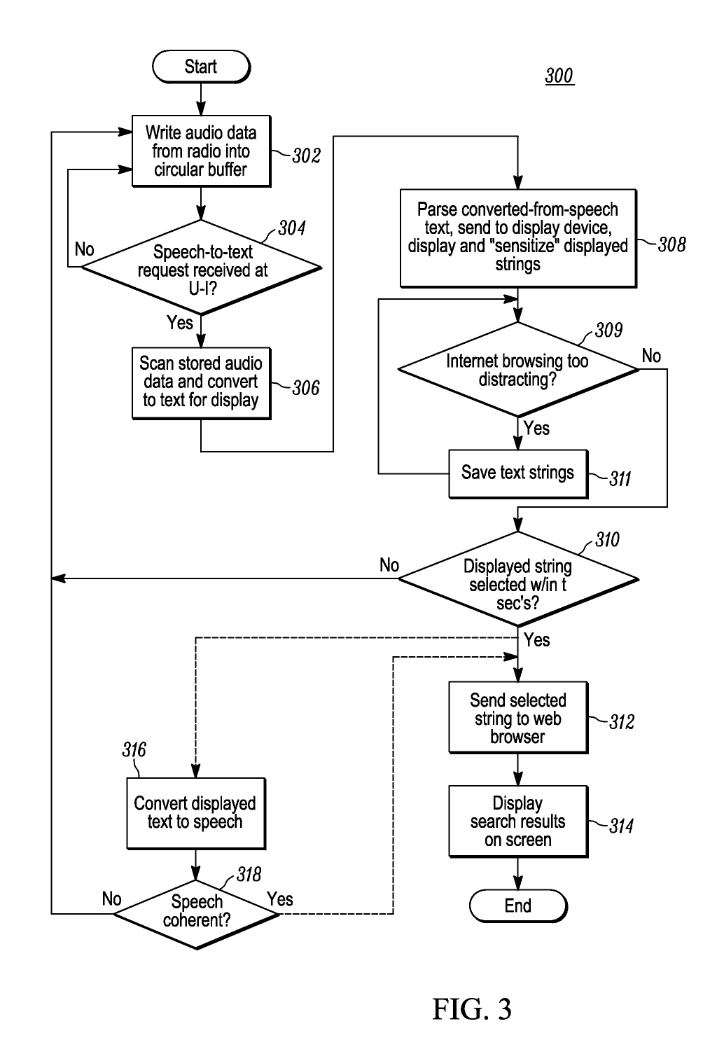

FIG. 3 depicts steps of a method 300 for automating Internet searches using audio obtained from a vehicle radio. Beginning at step 302, a group of digital values, i.e., eight or more bits of data representing a single sample of the audio signal received by a car radio, is written into a circular buffer in parallel, i.e., at the same time. After each such sample is written into the circular buffer at step 302, a test is conducted at step 304 to determine whether a request for a speech-to-text conversion was received at a user interface, such as a tactile input screen or touch sensitive display device. As described above, such a request is made by a person in the vehicle who wants to conduct an Internet search of a word, phrase, or sentence heard on the vehicle's radio. If no request for a speech-to-text conversion is received, the method 300 continues to write received audio data into the circular buffer. As described above, previously-stored data is eventually over-written with new data representing more recently-received audio. In a preferred embodiment, the circular buffer is sized to be able to record at least fifteen (15) seconds of audio up to about two (2) minutes of audio. The method 300 thus continues to overwrite audio data into the circular buffer continuously until a request for a speech-to-text conversion is received at a user interface.

If a request for speech-to-text conversion has been received at a user interface, such as a sensitized area of a touch screen, the method 300 proceeds to step 306 where the digital data in the circular buffer is retrieved by a processor and processed by a digital signal processor to convert the received audio data to strings of text. Step 306 thus requires speech to be recognized and converted to text, various techniques of which are well known, one example of which is a computer program known as DRAGON® published by Nuance Communications, Inc.

At step 308, speech that is converted to text is sent to a display device for display thereon, in a manner that allows sentences, phrases, and words to be spatially separated from each other on the display device. The spatial separation, as shown in FIG. 1 and identified by reference numerals 134 and 136, enables a sentence, phrase, or word to be selected by a user's touching the displayed sentence, phrase, or word. Step 308 therefore also includes sensitizing regions or areas of the display device where a string such as a sentence or phrase is displayed.

At step 309, a determination is made whether the vehicle's operating state, e.g., speed, location, time of day, number of occupants, makes it dangerous or unsafe to select displayed text or browse the Internet. By way of example, if the vehicle is moving and seat belt sensors indicate that the driver is the only occupant, the method 300 infers that selecting text on a display device and/or browsing Internet web sites should not be permitted. Accordingly, at step 311, strings to be displayed are saved in a memory device until it is determined at step 309 that it is safe to display text for selection.

At step 310, the method 300 waits a predetermined length of time, e.g. 15-20 seconds, for the user to select a displayed sentence, phrase or word. If nothing is selected after such a length of time, the method 300 returns to step 302 where the process of writing audio data into the circular buffer resumes. If a displayed string is selected at step 310, at step 312 the method sends the selected sentence, phrase, or word to a web browser process. The step of sending a selected string (sentence, phrase, or word) to a web browser comprises sending the string to either a remotely-located computer where a web browser process is running or a local computer, i.e., a computer in the vehicle. Regardless of whether a web browser process is running on a computer, conducting an Internet search from a vehicle requires a wireless link between the vehicle and an Internet service provider. Step 312 thus includes sending the string to be searched to a radio that provides a radio link to an Internet search provider. In one embodiment the step 312 of sending a selected string to a web browser includes sending the string to a remote computer via a radio link and receiving the results of that search the same way. In the embodiments where a process with the web browser is in the vehicle, the processor in the vehicle sends the command search from the web browser to a remotely located service provider. In either case, at step 314 the results of the Internet search are provided to the local processor in the vehicle controlling the display and thus displayed on the screen.

In an alternate embodiment, depicted as steps 316 and 318, when a displayed string is selected from the display device, the displayed string is passed to a text-to-speech convertor described above. At step 318, the user can decide whether the speech-to-text conversion was accurate by listening to the text-to-speech conversion performed at step 316. If at step 318 the speech generated from the text sounds coherent and thus accurate, the selected text is then be sent to a browser at step 312 for processing and the display of the results at step 314. If as a result of step 318 the speech is determined to be incoherent, the process returns to step 312 where audio from the radio is written into the circular buffer as before.

Those of ordinary skill in the art will recognize that steps 302 and 304 together provide the ability to start and stop the recording of digital data received from a radio responsive to an input received by the processor through a user interface such as a touch-sensitive display. The method 300 thus enables a user to continue listening to an audio program on his or her car radio and selectively recover for further investigation, portions of the program material using a web browser. Selected portions of the audio program can thus be presented for an Internet search based on the audio content by a few touch screen inputs automating and simplifying the process of searching the Internet from a vehicle.

The foregoing is for purposes of illustration only. The true scope of the invention is set forth in the following claims.

1. An apparatus to automate Internet searches using audio obtained from a vehicle radio, the apparatus comprising:
a radio configured to provide a stream of digital data representing audio that includes speech;
a circular buffer coupled to the radio and configured to continuously store digital data output from the radio, digital data received from the radio after the circular buffer is filled being written over previously stored digital data, the circular buffer being sized to store digital data representing between about fifteen seconds of audio, up to about two minutes of audio;
a speech-to-text converter coupled to the circular buffer and configured to convert digital data in the circular buffer into one or more strings of text that can be displayed on a display device;
a touch-sensitive display device coupled to the speech-to-text converter and configured to display a string of text produced by the speech-to-text converter, the touch-sensitive device being additionally configured to enable a tactile selection of displayed string of text, and also configured to receive a tactile input, which when provided to a processor, causes the processor to stop recordation of digital data into the circular buffer and which causes the processor convert the digital data in the circular buffer to text, capable of being displayed on said touch-sensitive display device; and
a processor coupled to the touch-sensitive display device and configured to perform an action responsive to selection of displayed text.

2. The apparatus of claim 1, further comprising a memory device coupled to the processor, the memory device storing program instructions for the processor, which when executed cause the processor to:
provide a first tactile sensitive area on the display panel, which when selected, causes the processor to stop recordation of digital data into the circular buffer;
after the recordation of digital data is stopped, convert the digital data stored in the circular buffer to text that can be displayed on the display panel; and
display the converted text on the display device in one or more touch-sensitive areas.

3. The apparatus of claim 1, wherein the speech-to-text converter is configured to parse speech into at least one of: sentences, phrases and words.

4. The apparatus of claim 3, wherein the touch-sensitive display device is configured to display sentences, phrases and words that are spatially separated from each other on the touch-sensitive display device.

5. The apparatus of claim 1, further comprising a radio transmitter coupled to the processor and which is configured to be able to couple the processor to a wireless data network.

6. The apparatus of claim 5, wherein the processor is additionally configured to forward a message to an Internet service provider via the radio.

7. (canceled)

8. The apparatus of claim 1, further comprising a text-to-speech converter configured to receive a string of text and synthesize speech from the string of text.

9. A method of automating Internet searches using audio obtained from a vehicle radio, the method comprising:
receiving from a radio, digital data that represents speech;
continuously storing the digital data representing speech in a circular buffer, which is sized to store digital data representing between about fifteen seconds of speech up to as much as a few minutes of speech, digital data received from the radio after the circular buffer is filled, being written over previously stored digital data;
receiving a stop recording signal, the stop recording signal causing a cessation of the storage of digital data into the circular buffer;
after the stop recording signal is received, converting digital data in the circular buffer representing speech to one or more strings of text that can be displayed on a display device;
providing the one or more strings of text to a touch-sensitive display device and displaying the one or more strings of text on the touch-sensitive display;
receiving a signal from the touch-sensitive display device, which represents a user's selection of a displayed string of text using the touch-sensitive display device; and
forming an Internet search from the selected displayed string of text.

10. (canceled)

11. The method of claim 9, wherein the step of converting digital data to a string of text comprises parsing speech into at least one of: sentences, phrases and words.

12. The method of claim 9, wherein the step of providing the string of text to a touch-sensitive display device and displaying the string of text comprises spatially separating a first displayed string of text from a second displayed string of text such that the first and second strings are vertically separated from each other.

13. The method of claim 9, wherein the step of forming an Internet search string further comprises providing a string of text selected from the display device to an Internet search engine running on a processor.

14. The method of claim 13, wherein the step of providing a string of text selected from the display device to an Internet search engine running on a processor comprises providing the string of text to a processor via a wireless communications link.

15. The method of claim 13, wherein the step of providing a string of text selected from the display device to an Internet search engine is performed after a first, user-determined delay time.

16. The method of claim 13, further comprising: converting displayed strings to speech and providing a text-to-speech converted string to an Internet search engine.

17. The method of claim 9, further comprising the steps of starting and stopping the recording of digital data received from the radio responsive to an input received through the touch-sensitive display.

18. (canceled)
